(19) United States
(12) Patent Application Publication
(10) Pub. No.: US 2024/0263875 A1
(43) Pub. Date: Aug. 8, 2024

(54) LYOPHILIZATION SYSTEM/LYOPHILIZER

(71) Applicant: AMGEN INC., Thousand Oaks, CA (US)

(72) Inventors: Philippe Lam, Belmont, MA (US); Gioval Scalzo, Newbury Park, CA (US); Nitin Rathore, Thousand Oaks, CA (US)

(21) Appl. No.: 18/564,675

(22) PCT Filed: May 24, 2022
(86) PCT No.: PCT/US22/30698

§ 371 Date: Nov. 28, 2023

Related U.S. Application Data
(60) Provisional application No. 63/195,424, filed on Jun. 1, 2021.

(51) Int. Cl. F26B 5/06; F26B 5/04

(52) U.S. Cl. CPC F26B 5/06; F26B 5/044

(57) ABSTRACT

A method of lyophilizing a target material includes placing a container with a target material in a lyophilizer of a lyophilization system. The lyophilization system includes the lyophilizer, a refrigeration system coupled to the lyophilizer, a temperature controller coupled to the refrigeration system, and a flow path connecting the lyophilizer and the refrigeration system. The method includes activating the lyophilizer where the lyophilizer includes a plurality of walls defining an interior chamber and at least one shelf disposed in the interior chamber. The method includes running a freezing cycle, running a primary drying cycle, and running a secondary drying cycle. The method includes pumping a thermal fluid through the flow path in fluid communication with the at least one shelf and at least one wall. Running the freezing cycle includes pumping the thermal fluid through the at least one wall of the plurality of walls.

### CROSS-REFERENCE TO RELATED APPLICATIONS

Priority is claimed to U.S. Provisional Patent Application No. 63/195,424, filed Jun. 1, 2021, the entire contents of which are hereby incorporated by reference herein.

### FIELD OF DISCLOSURE

The present disclosure is directed to a lyophilization system, and in particular, a lyophilization system with a temperature controller.

### BACKGROUND

Lyophilization, also referred to as freeze-drying, is a dehydration process typically used to preserve a perishable target material, such as a pharmaceutical product, or make the target material more convenient for transport. Lyophilization works by freezing the target material and then reducing the surrounding pressure and adding sufficient heat to allow the frozen solvent (typically water) in the target material to sublimate (i.e., a phase transition directly from a solid to a vapor). The vapor is then removed from the target material to complete dehydration, leaving the target material in dry powder form. A sterile diluent may later be introduced for reconstitution prior to being administered to a patient.

Conventional lyophilization processes are carried out with freeze-drying machines located within laboratories or production facilities, for example. These machines define internal chambers for processing containers with material to be lyophilized. For example, a known lyophilization system 10 is depicted in FIG. 1 and is used for performing a freezing and primary and secondary drying cycles. The lyophilization system 10 includes a freeze-drying machine, which may be referred to as a lyophilizer 14, such as an SP Hull LyoConstellation Freeze Dryer lyophilizer or LYOMAX industrial freezer, a refrigeration system 18, a thermal fluid heating and distribution system 22 coupled to the lyophilizer 14 and the refrigeration system 18, a vacuum pumping system 26, and an ice condenser 30. The thermal fluid heating and distribution system 22 has a single circulation circuit, where the fluid is pumped through an electrical immersion heater and then through a bank of refrigerant heat exchangers of the refrigeration system 18, depending on the required control setpoint. The system 10 includes one or more temperature probes or sensors 32 disposed throughout the system 10. The lyophilizer 14 includes a door 34, a plurality of walls 38, and an interior chamber 42 defined by the plurality of walls 38. Inside the interior chamber 42, parallel shelves 46 receive a plurality of vials 50 containing a target material. For heating and cooling the shelves 46 of the lyophilizer 14, the thermal fluid heating and distribution system 22 pumps thermal fluid through a flow path 56, which may include a network of conduits, that connects the machine 14 and the refrigeration system 18. The shelves 46 are arranged to receive a thermal fluid from the refrigeration system 18 to reduce or raise the temperature of a surface of the shelves 46.

In the schematic diagram of the system in FIG. 2, a temperature controller 58 controls the heating and cooling of the lyophilizer. The flow path 56 includes a first conduit 60 connected to the plurality of walls 38 and a second conduit 64 connected to the plurality of shelves 46. The conduits 60, 64 extend through the walls 38 and shelves 46 and receive the thermal fluid to heat or cool the shelves 46. As shown in FIG. 2, a valve 68 is disposed in the flow path 56 and between the thermal fluid heating and distribution system 22 and the plurality of walls 38. During the freezing and primary and secondary drying cycles, the valve 68 is closed so that thermal fluid from the thermal fluid and distribution system 22 runs through the flow path 56, through the second conduit 64 and into the plurality of shelves 46, and back into the thermal fluid heating and distribution system 22. The valve 68 is only open to cool the chamber walls 38 after a Steam-in-Place (SIP) cycle, which is a precursor cycle to sterilize the interior chamber 42 prior to loading the product into the lyophilizer 14.

Due to the configuration and normal processing of the machine, lyophilization may lead to inhomogeneity of large batches. For example, vials 52 (FIG. 1) disposed on the periphery of the shelves 46 are exposed to additional heat originating from the walls 38, whereas vials disposed internally relative to the periphery are shielded by their neighboring vials from the additional heat. To avoid overheating peripheral vials and damaging the product, drying conditions must be tempered, which leads to longer cycles.

In another example, a small-scale lyophilization system 70, such as an SP Hull LyoCapsule™ Freeze Dryer lyophilize, is shown in the schematic diagram of FIG. 3. This lyophilization system 70 is manufactured with independent chamber and shelf temperature controllers 74, 78 such that the chamber wall temperature can be controlled separately from the shelf temperature. By controlling the wall and shelf temperatures separately, the peripheral vials in these machines can be treated similarly to the internally disposed vials in the machine. These lyophilizers, however, are typically not implemented at product scale due to their complexity and expense.

### SUMMARY

In accordance with a first exemplary aspect, a method of lyophilizing a target material may include placing a container with a target material in a lyophilizer of a lyophilization system. The lyophilization system may include the lyophilizer, a refrigeration system coupled to the lyophilizer, a controller coupled to the refrigeration system, and a flow path connecting the lyophilizer and the refrigeration system. The method may include activating the lyophilizer. The lyophilizer may include a plurality of walls defining an interior chamber and at least one shelf disposed in the interior chamber. The method may include performing a freezing cycle by reducing a temperature of the at least one shelf. The method may include performing a primary drying cycle by increasing the temperature of the at least one shelf. The method may include performing a secondary drying cycle. Further, the method may include pumping a thermal fluid through the flow path during the freezing cycle, the primary drying cycle, and the secondary drying cycle. The flow path may be in fluid communication with the at least one shelf and in selective fluid communication with at least one wall of the plurality of walls. The method may include opening a valve disposed on the flow path during at least a portion of at least one of the freezing cycle and the secondary drying cycle to pump the thermal fluid through the at least one wall of the plurality of walls.

In accordance with a second exemplary aspect, a lyophilization system may include a plurality of walls defining a chamber and a shelf disposed in the chamber. A first conduit may be in fluid communication with at least one of the plurality of walls. A second conduit may be in fluid communication with the shelf. A valve may be operatively coupled to the first conduit. A sensor may be coupled to the first conduit to capture sensor data associated with a temperature of a thermal fluid flowing through the first conduit. A controller may be communicatively coupled to the lyophilizer to perform a freezing cycle, a primary drying cycle, and a secondary drying cycle. The controller may include one or more processors and a memory communicatively coupled to the one or more processors. The memory may store executable instructions that, when executed by the one or more processors, causes the one or more processors to receive sensor data captured by the at least one sensor, analyze the sensor data to identify a status or condition associated with the temperature of the thermal fluid flowing through the first conduit during at least one of the freezing cycle, primary drying cycle, and secondary drying cycle, and send a signal to the valve to open or close based on the status or condition identified during the at least one of the freezing cycle, primary drying cycle, and secondary drying cycle.

In accordance with a third exemplary aspect, a method of lyophilizing a target material may include placing a container with a target material in a lyophilizer of a lyophilization system. The lyophilization system may include the lyophilizer, a refrigeration system coupled to the lyophilizer, a temperature controller coupled to the refrigeration system, and a flow path connecting the lyophilizer and the refrigeration system. The method may include activating the lyophilizer, wherein the lyophilizer may include a plurality of walls defining an interior chamber and at least one shelf disposed in the interior chamber. The method may include performing a freezing cycle, performing a primary drying cycle, and performing a secondary drying cycle. The method may include capturing, by at least one sensor associated with a first conduit of the flow path, sensor data associated with a temperature of the thermal fluid flowing through the at least one wall of the plurality of walls of the lyophilizer. The method may include analyzing, by one or more processors of the temperature controller, the sensor data associated with the temperature of the thermal fluid flowing through the at least one wall of the plurality of walls. The method may include identifying, by one or more processors, based on an analysis of the sensor data, a status or condition associated with the temperature of the thermal fluid flowing through the at least one wall of the plurality of walls. The method may further include sending, during at least one of the freezing cycle, the primary drying cycle, and the secondary drying cycle, a signal to a valve to open or close based on the status or condition identified, wherein the valve is disposed in a first conduit of the flow path, the flow path including the first conduit connected to the at least one wall of the plurality of walls and a second conduit connected to the at least one shelf.

In further accordance with any one of the foregoing first, second, and third exemplary aspects, a method of lyophilizing and/or a lyophilization system may further include any one or more of the following preferred aspects.

In a preferred aspect, performing the freezing cycle may include opening the valve disposed in a first conduit of the flow path connected to the at least one wall of the plurality of walls.

In a preferred aspect, the method may include pumping thermal fluid into the at least one wall of the plurality of walls.

In a preferred aspect, performing the secondary drying cycle includes removing a portion of a remaining adsorbed or bound moisture from the target material to complete dehydration.

In a preferred aspect, performing the secondary drying cycle may include opening the valve and pumping thermal fluid into the at least one wall of the plurality of walls.

In a preferred aspect, opening the first conduit may include connecting the refrigeration system with the plurality of walls.

In a preferred aspect, performing the freezing cycle may include pumping the thermal fluid through the at least one shelf.

In a preferred aspect, the method may include closing the valve before performing the primary drying cycle.

In a preferred aspect, closing the valve may include shunting thermal fluid from entering the at least one wall of the plurality of walls.

In a preferred aspect, the method may include capturing, by at least one sensor associated with the first conduit, sensor data associated with a temperature of the thermal fluid flowing through the at least one wall of the plurality of walls of the lyophilizer.

In a preferred aspect, the method may include analyzing, by one or more processors of the temperature controller, the sensor data associated with the temperature of the thermal fluid flowing through the at least one wall of the plurality of walls.

In a preferred aspect, the method may include identifying, by one or more processors, based on an analysis of the sensor data, a status or condition associated with the temperature of the thermal fluid flowing through the at least one wall of the plurality of walls.

In a preferred aspect, the method may include sending a signal to the valve to open or close based on the status or condition identified.

In a preferred aspect, a refrigeration system may be communicatively coupled to the controller.

In a preferred aspect, the executable instructions may cause the one or more processors to send a signal to the refrigeration system to pump a thermal fluid based on a status or condition associated with the temperature of the thermal fluid flowing through the first conduit.

In a preferred aspect, a network of conduits may include the first conduit and the second conduit.

In a preferred aspect, the first conduit may be in fluid communication with the plurality of walls defining the chamber.

In a preferred aspect, the plurality of walls may include a first sidewall, a second sidewall, a ceiling, and a floor.

In a preferred aspect, the method may include pumping a thermal fluid through the flow path during at least one of the freezing cycle, the primary drying cycle, and the secondary drying cycle.

In a preferred aspect, the method may include opening and closing the valve during pumping such that when the valve is open, thermal fluid is pumped into the first conduit and the second conduit, and when the valve is closed, thermal fluid is pumped into the second conduit.

### BRIEF DESCRIPTION OF THE DRAWINGS

FIG. 1 is an exemplary diagram of a conventional lyophilization system with a temperature controller assembled in accordance with the teachings of the present disclosure;

FIG. 2 is a schematic temperature control flow diagram of the lyophilization system of FIG. 1;

FIG. 3 is a schematic temperature control flow diagram of a lyophilizer having independent temperature controls;

FIG. 4 is a flowchart representative of an exemplary lyophilization process executed by a temperature controller in accordance with the teachings of the present disclosure, and carried out on the conventional lyophilizer depicted in FIG. 1;

FIG. 5 is the schematic temperature control flow diagram of FIG. 1 showing the system during a conventional freezing cycle;

FIG. 6 is the schematic temperature control flow diagram of FIG. 1, showing the system during a freezing cycle of FIG. 4 in accordance with the teachings of the present disclosure;

FIG. 7 is the schematic temperature control flow diagram of FIG. 1, showing the system during a conventional primary drying cycle;

FIG. 8 is the schematic temperature control flow diagram of FIG. 1, showing the system during a primary drying cycle of FIG. 4 in accordance with the teachings of the present disclosure;

FIG. 9 is the schematic temperature control flow diagram of FIG. 1, showing the system during a conventional secondary drying cycle; and

FIG. 10 is a schematic temperature control flow diagram of FIG. 1, showing the system during a secondary drying cycle of FIG. 4 in accordance with the teachings of the present disclosure.

### DETAILED DESCRIPTION

A lyophilization system of the present disclosure reduces the heat differential between peripheral and internally disposed vials in a conventional large-scale lyophilizer by operating the thermal fluid circuit in such a way as to mimic the functionality of a small-scale lyophilizer having independent chamber and shelf temperature controls. By controlling the temperature of a jacket (i.e., the chamber walls, floor, ceiling) of the lyophilizer, the disclosed system can lyophilize large batches efficiently and more uniformly, thereby yielding higher operational throughput.

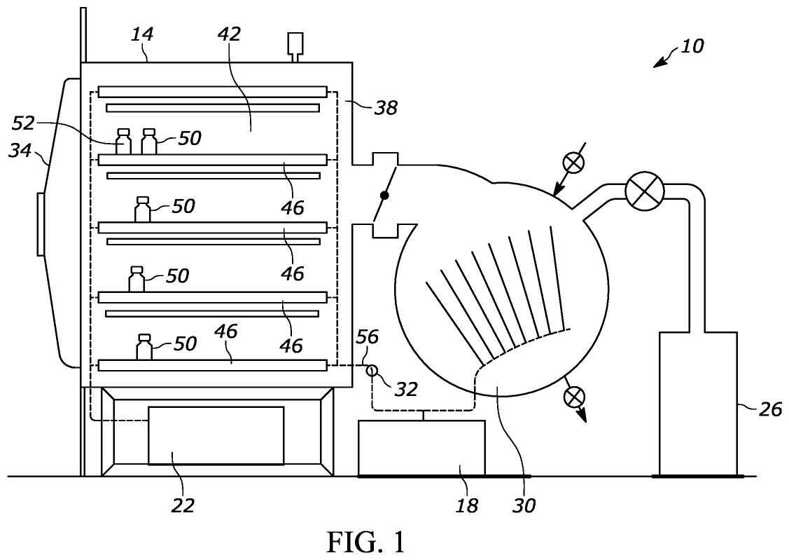

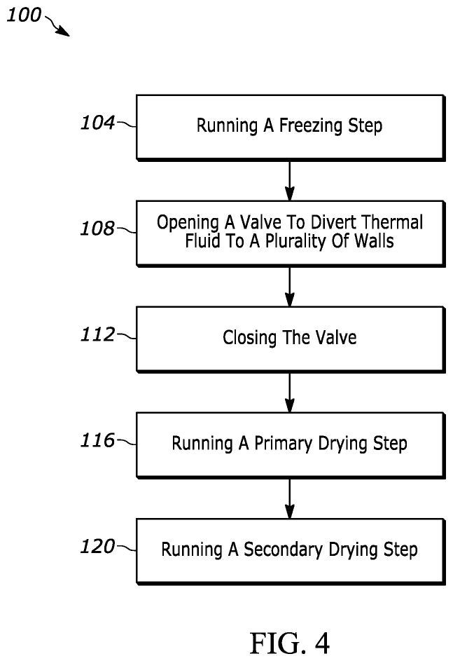

In FIG. 4, an exemplary process of lyophilization 100 is depicted in accordance with the teachings of the present disclosure. A plurality of containers 50, 52 containing a product for freeze-drying is placed on the shelves 46 of the lyophilizer 14, such as the lyophilizer 14 of FIG. 1. The plurality of containers 50, 52 contain a liquid target product and are arranged in rows or groups in such a way that there are peripheral containers 52 disposed along a perimeter of the shelf 46, and internal containers 50 disposed interior to the peripheral containers 52. The peripheral containers 52 are closest to the surrounding chamber walls 38, and are therefore exposed to the temperature of the plurality of walls 38 during lyophilization. The chamber walls 38 include a floor, a ceiling, and a plurality of sidewalls, and receive thermal fluid to affect the temperature of the interior surfaces of the chamber walls 38. Similarly, the plurality of shelves 46 also receive thermal fluid to change the temperature of the surface of the shelves 46. By comparison to the peripheral container 52, the internal containers 50 are shielded by the peripheral containers 52 from the temperature of the plurality of walls 38. After the containers 50, 52 are placed within the lyophilizer 14, the door 34 is shut, sealed, and the lyophilizer 14 is activated to run the freeze drying cycle.

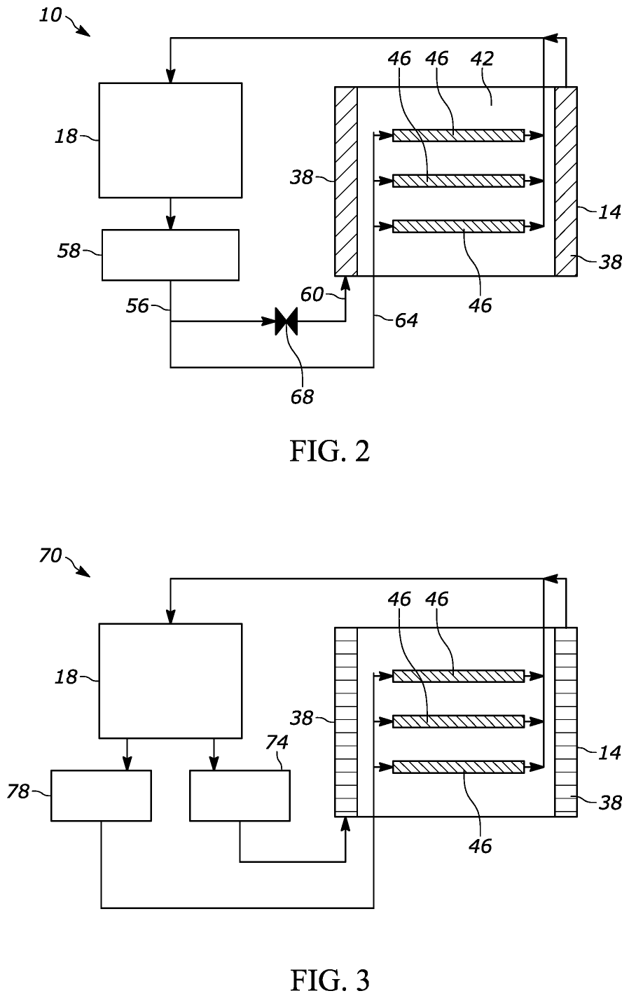

During a freezing cycle 104 of the method 100, the temperature of the chamber 42 is reduced to a temperature in the range of approximately negative forty degrees Celsius (−40° C.) to approximately negative fifty-five degrees Celsius (−55° C.), for example. Other ranges of temperatures are intended to be within the scope of the present disclosure. To reduce the temperature of the machine 14, the thermal fluid heating and distribution system 22 pumps thermal fluid from the refrigeration system 18 and through the flow path 56 to the lyophilizer 14. The flow path 56 connects the thermal fluid source with exterior and interior conduits connected to and running through the lyophilizer 14. As shown in FIG. 2, the flow path 56 creates a loop connecting the thermal fluid heating and distribution system 22 to the lyophilizer 14. By circulating thermal fluid through the lyophilizer 14, the surfaces of the shelves 46 may be cooled or heated for the processing cycles. For example, the surfaces of the shelves 46 may be cooled or heated at a rate in a range of approximately 0.4° C. per minute to approximately 1° C. per minute.

The method 100 includes a step of opening 108 the valve 68 disposed in the flow path 56 to divert the thermal fluid into both the plurality of walls 38 and the plurality of shelves 46 to freeze the target material contained in the plurality of containers 50. Once a temperature condition of the chamber walls 38 is achieved, the method 100 includes closing 112 the valve 68 before running a primary drying cycle 116. Then, the method 100 includes running the primary drying cycle 116 which includes reducing the surrounding pressure inside of the chamber 42 and adding sufficient heat (depending on the product) to the shelves 46 to allow the frozen solvent (typically water) in the target material to sublimate directly from a solid to a vapor. Heat is added to the shelves 46 by running thermal fluid through the flow path 56 and into the plurality of shelves 46. The ambient pressure of the interior chamber 42 is reduced with the vacuum pump 26, for example, to a pressure that is substantially less than atmospheric pressure, such as a pressure in the range of approximately 0.03 Torr to approximately 0.3 Torr. Other ranges between atmospheric pressure and absolute vacuum are intended to be within the scope of the present disclosure. The sublimated water is removed from the target material during the primary drying cycle 116 and dissipates out of the vials. Some moisture remains “bound” to or adsorbed by the apparently dry product. This is removed in the secondary drying cycle. After the primary drying cycle 116, the lyophilizer 14 runs a secondary drying cycle 120 to remove a portion of the remaining adsorbed or bound moisture from the target material to complete dehydration. During the secondary drying cycle 120, the method 100 includes opening 108 the valve 68 again to divert thermal fluid into both the plurality of walls 38 and the plurality of shelves 46 of the machine 14. The temperature of the thermal fluid running through both the shelves 46 and the walls 38 is approximately 30° C., and the chamber pressure remains the same as the primary drying cycle 116. The remaining moisture is desorbed to reduce the residual moisture content of the primary freeze-dried material, leaving a target material in powder form in the plurality of containers 50.

The method 100 of FIG. 4 may be performed by operating a controller 58 communicatively coupled to the various systems and components of the lyophilization system 10. In the disclosed exemplary process 100, the controller 58 is configured to also open 108 and close 112 the valve 68 during the freezing, primary, and secondary drying cycles 104, 116, 120, to provide for a more homogenous and efficient lyophilization process. The controller 58 is communicatively coupled to the lyophilizer 14 and includes one or more processors and a memory communicatively coupled to the one or more processors and which stores executable instructions. In one exemplary process, when the stored instructions are executed, the one or more processors receive sensor data captured by at least one sensor 32, for example, a temperature probe disposed in the flow path 56 of the first conduit 60, and analyze the sensor data to identify a status or condition associated with the temperature of the thermal fluid flowing through the flow path 56. Based on status or condition identified, the controller 58 may send a signal to the valve 68 to open or close.

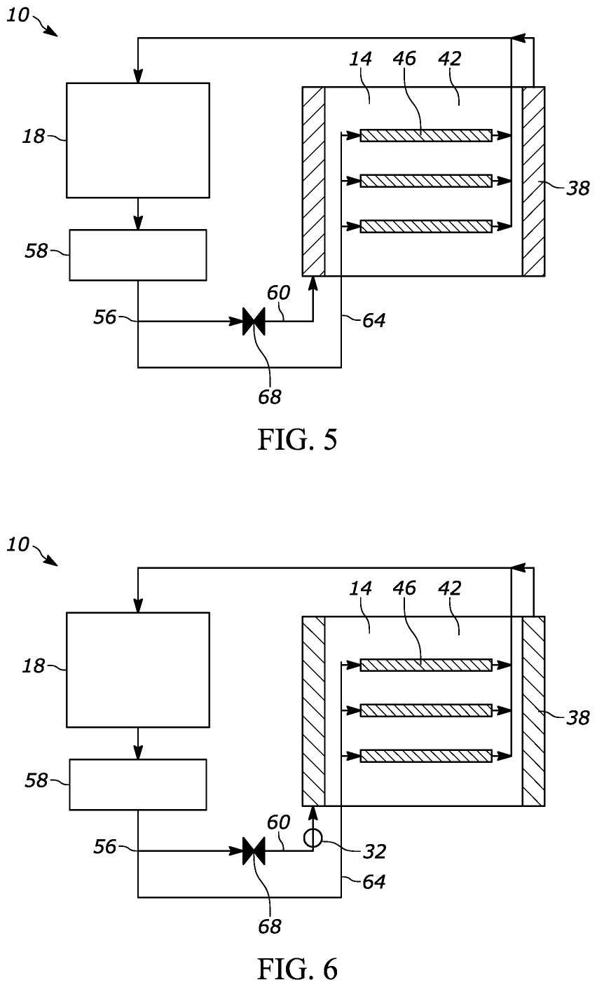

To help illustrate how the disclosed process 100 differs from conventional methodology, each step of the process 100 of FIG. 4 is described again with reference to the conventional method of lyophilization where the valve 68 remains closed through each of the freezing, primary, and secondary drying cycles (as shown in FIGS. 5, 7, and 9). Each conventional cycle is compared to the cycles of the present disclosure by illustrating the controller 58 operating the valve 68 to control thermal fluid flow through the machine 14 during the freezing, primary, and secondary drying cycles (FIGS. 6, 8, and 10).

Turning first to FIG. 5, a conventional freezing cycle is illustrated. As previously described, during a freezing cycle, a temperature of the shelves 46 is reduced to induce crystallization of the bulk of the contained water in the containers 50. The temperature of the surfaces of the shelves 46 of the lyophilizer 14 is controlled by controlling the thermal fluid which runs through the plurality of shelves 46. As shown in FIG. 5, the valve 68 disposed in the flow path 56 is closed such that the plurality of walls 38 do not receive the thermal fluid (i.e., the walls are shunted) pumped into the shelves 46. As a result, a temperature of the chamber walls 38 is higher than the shelf temperature (e.g., ambient temperature), therefore creating a temperature differential between the outer periphery and surface portions of a given shelf 46. As the shelves cool, the environment within the chamber naturally cools; and as the inner chamber environment cools, the temperature of the inner chamber wall surfaces 38 also cools, but not at the same rate as the shelves 46.

By comparison, in the freezing cycle 104 of the disclosed process 100 as shown in FIG. 6, a temperature within the lyophilizer 14 is reached by cooling both the shelves 46 and walls 38. As shown in FIG. 6, the valve 68 is open such that thermal fluid is pumped into both the shelves 46 and the walls 38 of the lyophilizer 14. In particular, the thermal fluid has a temperature in the range of approximately negative forty degrees Celsius (−40° C.) to approximately negative fifty-five degrees Celsius)(−55° ° C., depending on the product, and runs through both the first conduit 60 and the second conduit 64. The first conduit 60 may include external and/or internal conduits connecting the flow path 56 with interior pathways disposed in each of the plurality of walls 38. At the same time, thermal fluid runs through the second conduit 64, which may include external and/or internal conduits connecting the flow path 56 with interior pathways disposed in each of the shelves 46. The thermal fluid reduces the shelf temperature and the chamber wall temperature to reduce the temperature of the machine 14 and freeze the target product. Because the temperature of the walls 38 and the shelves 46 are similarly cooled, the temperature difference between the shelves 46 and the walls 38 is reduced by comparison to the conventional freezing cycle of FIG. 5. As a result, the freezing cycle 104 shown in FIG. 6 achieves more efficient and uniform freezing across all containers on each shelf 46, regardless of the container location relative to the chamber walls 38 of the lyophilizer 14.

In this cycle, the controller 58 may continuously receive and analyze sensor data of the one or more sensors disposed throughout the system 10 and communicate with the valve 68 to operate the lyophilizer 140. In particular, the sensor 32 disposed along the first conduit 60 measures the temperature of the fluid flowing through the plurality of walls 38 and communicates the sensor data to the controller 58. The controller 58 may be programmed to open the valve 68 at the beginning of the freezing cycle, and close the valve once the temperature of the walls 38 reaches a particular temperature threshold (i.e., meets a pre-programmed condition or status), for example negative ten degrees Celsius (−10° C.). When a temperature condition is met, the controller 58 communicates with the valve 68 to close for a period of time or until the chamber wall temperature reaches a different temperature during the freezing cycle (i.e., meets another pre-programmed condition or status), for example ten degrees Celsius (10° C.). At which point, the controller 58 sends a signal to the valve 68 to open, thereby allowing thermal fluid to pump into the walls 38 of the lyophilizer 14 once again. Based on the needs of the system 10, the controller 58 may operate to open and close the valve 68 once or multiple times throughout the freezing cycle.

In another example, the controller 58 may be programmed to open the valve 68 based on the passage of time or other temperature or pressure conditions of the system 10. The controller 58 may be programmed to continuously or intermittently open and close the valve 68 variously throughout the freezing cycle. By controlling the valve 68, and thereby controlling the flow of thermal fluid through the walls 38 of the lyophilizer 14, the disclosed method 100 can better regulate the temperature of both the shelves 46 and walls 38, thereby mimicking a dual-temperature controller of the lyophilization system of FIG. 3. In another example, the controller 58 may be programmed to control the temperature and pumping of the thermal fluid through the lyophilizer 14.

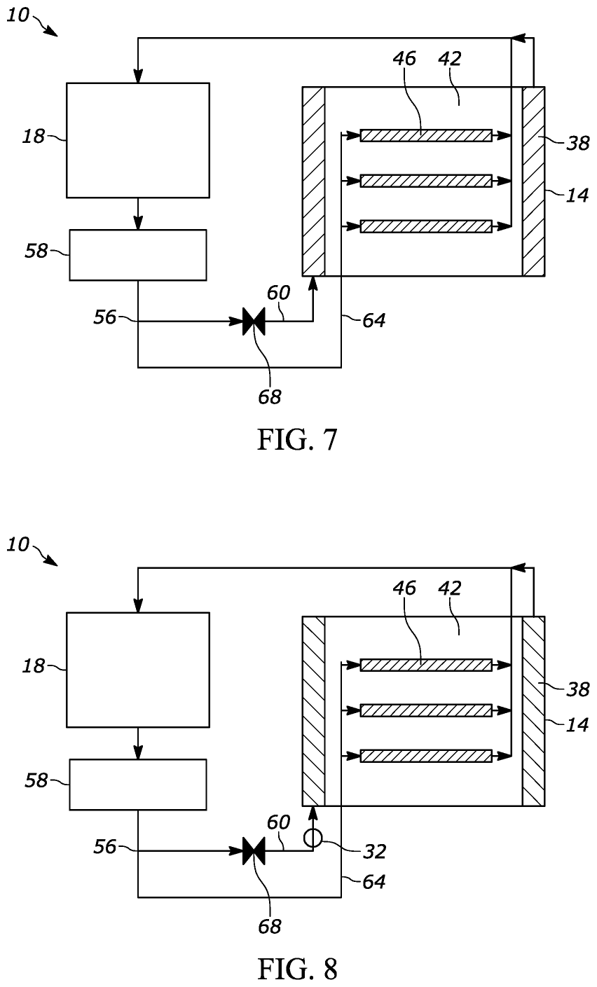

In a conventional primary drying cycle, as shown in FIG. 7, the ice formed in the freezing cycle is removed from the product by sublimation. This cycle is complete when all ice has disappeared. As shown in FIG. 7, the valve 68 remains closed as the thermal fluid is pumped into the shelves 46 to increase the temperature of the shelves 46. The ambient pressure of the interior chamber 42 is reduced while heat is added to the lyophilization shelves 46 to sublimate the frozen water in the target material from a solid to a vapor. The peripheral containers 52 are exposed to additional heat, for example, by convection or radiation, from the plurality of walls 38, thereby causing the target product of the peripheral containers 52 to heat faster than the interior containers 50. Different drying rates of the target product between the peripheral containers 52 and interior containers 50 can lead to inhomogeneity of the entire batch. To avoid inhomogeneity, the duration of the conventional primary drying cycle is tailored for the slower drying rates of the interior containers 50 even though the peripheral containers 52 have completed drying.

In FIG. 8, the primary drying cycle 116 of the disclosed process 100 depicts the valve 68 in a closed position. As such, the thermal fluid heating and distribution system 22 pumps thermal fluid through the shelves 46, while the plurality of walls 38 remain at a lower temperature from previously circulating thermal fluid in the freezing cycle 104. For example, the thermal fluid has a temperature in a range of approximately negative thirty-five degrees Celsius (−40° C.) to approximately zero degrees Celsius (0° C.), and preferably negative thirty degrees Celsius (−30° C.), depending on the product being lyophilized. As a result, the walls 38 contribute less heat to the peripheral containers disposed on the shelves 46, thereby reducing inhomogeneity of the peripheral and interior containers 52, 50. The residual cold carried by the chamber walls 38 from the freezing cycle 104 depresses the drying rate of the peripheral containers 52, thereby reducing inhomogeneity. As a result, a shelf temperature setpoint may be increased (compared to the shelf temperature of a conventional cycle), thereby increasing the drying speed of the interior containers 50, without overheating the peripheral containers 52, allowing for a net reduction in overall cycle time.

Again, the controller 58 may continuously receive and analyze sensor data of the one or more sensors disposed throughout the system 10 and communicate with the valve 68 to operate the lyophilizer 140 according to the method 100. Although FIG. 8 illustrates the valve 68 in the closed position, the controller 58 may open the valve 68 during this cycle if a stored condition or status is met. In one example, the controller 58 may be programmed to open the valve 68 based on the passing of a particular time, a temperature sensed in the flow path or interior chamber, or other conditions of the system 10. The controller 58 may be programmed to continuously or intermittently open and close the valve 68 variously throughout the primary drying cycle.

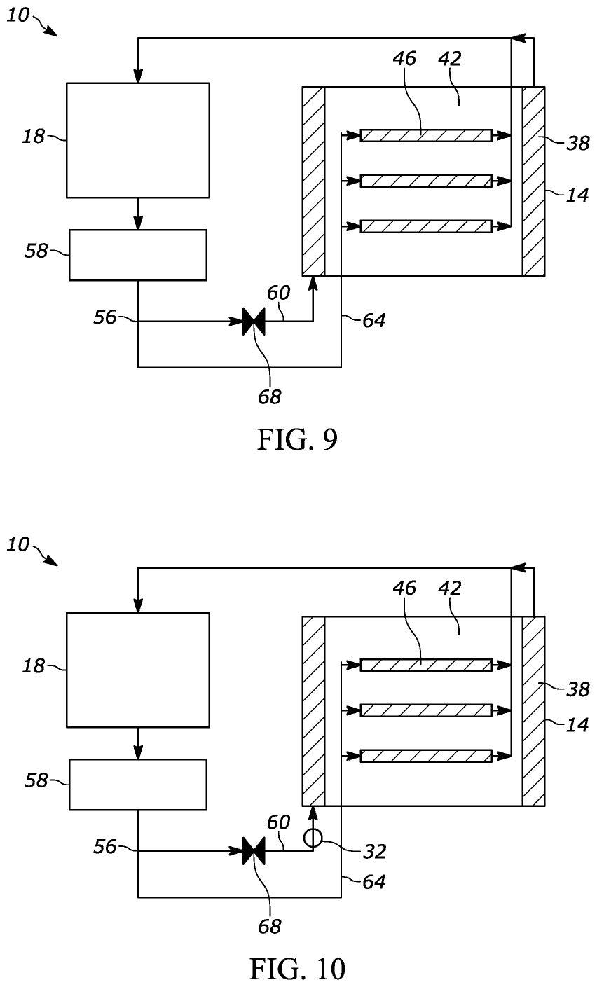

After the primary drying cycle completes, the lyophilizer 14 will run the secondary drying cycle. In a conventional secondary drying cycle, as shown in FIG. 9, the remaining moisture is desorbed to reduce the residual moisture content of the primary freeze-dried material. In FIG. 9, the valve 68 remains closed as the thermal fluid is again pumped into the plurality of shelves 46. In this arrangement, thermal fluid runs through the shelves 46 to provide heat to the shelves 46 and the chambers walls 38 are disconnected from the flow path 56. The chamber walls 38 are at a lower temperature than the shelves 46, thereby exposing the peripheral containers 52 on the shelves 46 to a lower temperature. The peripheral containers 52 block the internally disposed containers 50 from the temperature gradient of the walls 38.

By comparison, in a secondary drying cycle 120 of the disclosed process 100 shown in FIG. 10, the valve 68 is open, allowing thermal fluid to run through both the first and second conduits 60, 64 and therefore into the plurality of walls 38 and shelves 46 of the lyophilizer 14. The thermal fluid has a higher temperature than in the primary drying cycle, for example, and has a temperature in the range of approximately twenty-five degrees Celsius (25° C.) to approximately thirty-five degrees Celsius (35° C.), and preferably thirty degrees Celsius (30° C.), depending on the product being lyophilized. Thus the outer peripheral containers 52 are not exposed to cooler temperatures. By reducing the temperature differential of the shelves 46 and the walls 38, inhomogeneity of the containers 50 is reduced.

In this cycle, the controller 58 may continuously receive and analyze sensor data of the one or more sensors disposed throughout the system 10 and communicate with the valve 68 to operate the lyophilizer 140. In particular, the sensor 32 disposed along the first conduit 60 measures the temperature of the fluid flowing through the plurality of walls 38 and communicates the sensor data to the controller 58. The controller 58 may be programmed to open the valve 68 at the beginning of the secondary drying cycle, and close the valve 68 once the temperature of the walls 38 reaches a particular temperature threshold (i.e., meets a pre-programmed condition or status). When a temperature condition is met, the controller 58 communicates with the valve 68 to close for a period of time or until the chamber wall temperature reaches a different temperature during the secondary drying cycle (i.e., meets another pre-programmed condition or status). In another example, the controller 58 may be programmed to open the valve 68 based on other conditions of the system 10. The controller 58 may be programmed to continuously or intermittently open and close the valve 68 variously throughout the secondary drying cycle.

After a complete lyophilization cycle, the machine 14 then raises the ambient pressure within the lyophilization chamber 42 for aeration and stoppering cycles. During an aeration cycle, sterile filtered vapor breaks the vacuum of the system. This releases the pressure in the product chamber for stoppering the vials containing the freeze-dried product. In some embodiments, the pressure in the lyophilization chamber 42 can be raised by deactivating the vacuum pump and opening a vent, for example, to allow the pressure to stabilize relative to the pressure outside the freeze-drying machine 14. In some embodiments, the pressure in the lyophilization chamber 42 is raised to be substantially equal to atmospheric pressure, i.e., 101 kPa. Finally, during a stoppering event, a shelf stack may be used to force the stoppers fully into the vials prior to unloading the vials to seal the vials. The containers can then be removed.

The disclosed lyophilization system 10 and method 100 utilize existing freeze-drying machines 14 in a new way to improve homogeneity of the target powder product. By comparison to the dual-temperature control system of FIG. 3, the disclosed process is used on existing lyophilization systems that are simpler, capable of processing large batches of a target product, and less expensive. The disclosed lyophilization system 10 utilizes the valve 68, typically only used during a Steam-In-Place (SIP) cycle, to control the temperature of the interior surfaces of the chamber walls 38. The disclosed system 10 and process 100 reduce the temperature differential between the periphery of the shelves 46 and the center of the shelves 46 by controlling the temperature of the walls 38. In the conventional process, the inner chamber wall surfaces are cooled passively as the shelves 46 are cooled. By comparison, the disclosed system 10 and process 100 improve homogeneity of the batches at faster speeds by actively cooling the inner chamber wall surfaces. Additionally, the disclosed lyophilization system 10 and method 100 allow for an increased rate in the drying cycles because the inhomogeneity is reduced. Additionally, the disclosed system 10 and method 100 utilize existing probes and sensors and controller 58 to define specific temperature values that would trigger the opening of the valve for a specific duration or to meet a specific temperature, status or condition, depending on the phase of the lyophilization cycle. The exemplary system 10 and method 100 may optimize the lyophilization process by increasing the shelf temperature setpoint during the primary and secondary drying cycles to increase the drying speed of the interior containers 50 without overheating the peripheral containers 52, resulting in a net reduction in overall cycle time.

The above description describes various devices, assemblies, components, subsystems and methods for use related to a drug delivery device. The devices, assemblies, components, subsystems, methods or drug delivery devices can further comprise or be used with a drug including but not limited to those drugs identified below as well as their generic and biosimilar counterparts. The term drug, as used herein, can be used interchangeably with other similar terms and can be used to refer to any type of medicament or therapeutic material including traditional and non-traditional pharmaceuticals, nutraceuticals, supplements, biologics, biologically active agents and compositions, large molecules, biosimilars, bioequivalents, therapeutic antibodies, polypeptides, proteins, small molecules and generics. Non-therapeutic injectable materials are also encompassed. The drug may be in liquid form, a lyophilized form, or in a reconstituted from lyophilized form. The following example list of drugs should not be considered as all-inclusive or limiting.

The drug will be contained in a reservoir. In some instances, the reservoir is a primary container that is either filled or pre-filled for treatment with the drug. The primary container can be a vial, a cartridge or a pre-filled syringe.

In some embodiments, the reservoir of the drug delivery device may be filled with or the device can be used with colony stimulating factors, such as granulocyte colony-stimulating factor (G-CSF). Such G-CSF agents include but are not limited to Neulasta® (pegfilgrastim, pegylated filgastrim, pegylated G-CSF, pegylated hu-Met-G-CSF) and Neupogen® (filgrastim, G-CSF, hu-MetG-CSF), UDENYCA® (pegfilgrastim-cbqv), Ziextenzo® (LA-EP2006; pegfilgrastim-bmez), or FULPHILA (pegfilgrastim-bmez).

In other embodiments, the drug delivery device may contain or be used with an erythropoiesis stimulating agent (ESA), which may be in liquid or lyophilized form. An ESA is any molecule that stimulates erythropoiesis. In some embodiments, an ESA is an erythropoiesis stimulating protein. As used herein, “erythropoiesis stimulating protein” means any protein that directly or indirectly causes activation of the erythropoietin receptor, for example, by binding to and causing dimerization of the receptor. Erythropoiesis stimulating proteins include erythropoietin and variants, analogs, or derivatives thereof that bind to and activate erythropoietin receptor; antibodies that bind to erythropoietin receptor and activate the receptor; or peptides that bind to and activate erythropoietin receptor. Erythropoiesis stimulating proteins include, but are not limited to, Epogen® (epoetin alfa), Aranesp® (darbepoetin alfa), Dynepo® (epoetin delta), Mircera® (methyoxy polyethylene glycol-epoetin beta), Hematide®, MRK-2578, INS-22, Retacrit® (epoetin zeta), Neorecormon® (epoetin beta), Silapo® (epoetin zeta), Binocrit® (epoetin alfa), epoetin alfa Hexal, Abseamed® (epoetin alfa), Ratioepo® (epoetin theta), Eporatio® (epoetin theta), Biopoin® (epoetin theta), epoetin alfa, epoetin beta, epoetin iota, epoetin omega, epoetin delta, epoetin zeta, epoetin theta, and epoetin delta, pegylated erythropoietin, carbamoylated erythropoietin, as well as the molecules or variants or analogs thereof.

Among particular illustrative proteins are the specific proteins set forth below, including fusions, fragments, analogs, variants or derivatives thereof: OPGL specific antibodies, peptibodies, related proteins, and the like (also referred to as RANKL specific antibodies, peptibodies and the like), including fully humanized and human OPGL specific antibodies, particularly fully humanized monoclonal antibodies; Myostatin binding proteins, peptibodies, related proteins, and the like, including myostatin specific peptibodies; IL-4 receptor specific antibodies, peptibodies, related proteins, and the like, particularly those that inhibit activities mediated by binding of IL-4 and/or IL-13 to the receptor; Interleukin 1-receptor 1 (“IL1-R1”) specific antibodies, peptibodies, related proteins, and the like; Ang2 specific antibodies, peptibodies, related proteins, and the like; NGF specific antibodies, peptibodies, related proteins, and the like; CD22 specific antibodies, peptibodies, related proteins, and the like, particularly human CD22 specific antibodies, such as but not limited to humanized and fully human antibodies, including but not limited to humanized and fully human monoclonal antibodies, particularly including but not limited to human CD22 specific IgG antibodies, such as, a dimer of a human-mouse monoclonal hLL2 gamma-chain disulfide linked to a human-mouse monoclonal hLL2 kappa-chain, for example, the human CD22 specific fully humanized antibody in Epratuzumab, CAS registry number 501423-23-0; IGF-1 receptor specific antibodies, peptibodies, and related proteins, and the like including but not limited to anti-IGF-1R antibodies; B-7 related protein 1 specific antibodies, peptibodies, related proteins and the like (“B7RP-1” and also referring to B7H2, ICOSL, B7h, and CD275), including but not limited to B7RP-specific fully human monoclonal IgG2 antibodies, including but not limited to fully human IgG2 monoclonal antibody that binds an epitope in the first immunoglobulin-like domain of B7RP-1, including but not limited to those that inhibit the interaction of B7RP-1 with its natural receptor, ICOS, on activated T cells; IL-15 specific antibodies, peptibodies, related proteins, and the like, such as, in particular, humanized monoclonal antibodies, including but not limited to HuMax IL-15 antibodies and related proteins, such as, for instance, 145c7; IFN gamma specific antibodies, peptibodies, related proteins and the like, including but not limited to human IFN gamma specific antibodies, and including but not limited to fully human anti-IFN gamma antibodies; TALL-1 specific antibodies, peptibodies, related proteins, and the like, and other TALL specific binding proteins; Parathyroid hormone (“PTH”) specific antibodies, peptibodies, related proteins, and the like; Thrombopoietin receptor (“TPO-R”) specific antibodies, peptibodies, related proteins, and the like; Hepatocyte growth factor (“HGF”) specific antibodies, peptibodies, related proteins, and the like, including those that target the HGF/SF:cMet axis (HGF/SF:c-Met), such as fully human monoclonal antibodies that neutralize hepatocyte growth factor/scatter (HGF/SF); TRAIL-R2 specific antibodies, peptibodies, related proteins and the like; Activin A specific antibodies, peptibodies, proteins, and the like; TGF-beta specific antibodies, peptibodies, related proteins, and the like; Amyloid-beta protein specific antibodies, peptibodies, related proteins, and the like; c-Kit specific antibodies, peptibodies, related proteins, and the like, including but not limited to proteins that bind c-Kit and/or other stem cell factor receptors; OX40L specific antibodies, peptibodies, related proteins, and the like, including but not limited to proteins that bind OX40L and/or other ligands of the OX40 receptor; Activase® (alteplase, tPA); Aranesp® (darbepoetin alfa) Erythropoietin [30-asparagine, 32-threonine, 87-valine, 88-asparagine, 90-threonine], Darbepoetin alfa, novel erythropoiesis stimulating protein (NESP); Epogen® (epoetin alfa, or erythropoietin); GLP-1, Avonex® (interferon beta-1a); Bexxar® (tositumomab, anti-CD22 monoclonal antibody); Betaseron® (interferon-beta); Campath® (alemtuzumab, anti-CD52 monoclonal antibody); Dynepo® (epoetin delta); Velcade® (bortezomib); MLN0002 (anti-?4β7 mAb); MLN1202 (anti-CCR2 chemokine receptor mAb); Enbrel® (etanercept, TNF-receptor/Fc fusion protein, TNF blocker); Eprex® (epoetin alfa); Erbitux® (cetuximab, anti-EGFR/HER1/c-ErbB-1); Genotropin® (somatropin, Human Growth Hormone); Herceptin® (trastuzumab, anti-HER2/neu (erbB2) receptor mAb); Kanjinti™ (trastuzumab-anns) anti-HER2 monoclonal antibody, biosimilar to Herceptin®, or another product containing trastuzumab for the treatment of breast or gastric cancers; Humatrope® (somatropin, Human Growth Hormone); Humira® (adalimumab); Vectibix® (panitumumab), Xgeva® (denosumab), Prolia® (denosumab), Immunoglobulin G2 Human Monoclonal Antibody to RANK Ligand, Enbrel® (etanercept, TNF-receptor/Fc fusion protein, TNF blocker), Nplate® (romiplostim), rilotumumab, ganitumab, conatumumab, brodalumab, insulin in solution; Infergen® (interferon alfacon-1); Natrecor® (nesiritide; recombinant human B-type natriuretic peptide (hBNP); Kineret® (anakinra); Leukine® (sargamostim, rhuGM-CSF); LymphoCide® (epratuzumab, anti-CD22 mAb); Benlysta™ (lymphostat B, belimumab, anti-BlyS mAb); Metalyse® (tenecteplase, t-PA analog); Mircera® (methoxy polyethylene glycol-epoetin beta); Mylotarg® (gemtuzumab ozogamicin); Raptiva® (efalizumab); Cimzia® (certolizumab pegol, CDP 870); Soliris™ (eculizumab); pexelizumab (anti-C5 complement); Numax® (MEDI-524); Lucentis® (ranibizumab); Panorex® (17-1A, edrecolomab); Trabio® (lerdelimumab); TheraCim hR3 (nimotuzumab); Omnitarg (pertuzumab, 2C4); Osidem® (IDM-1); OvaRex® (B43.13); Nuvion® (visilizumab); cantuzumab mertansine (huC242-DM1); NeoRecormon® (epoetin beta); Neumega® (oprelvekin, human interleukin-11); Orthoclone OKT3® (muromonab-CD3, anti-CD3 monoclonal antibody); Procrit® (epoetin alfa); Remicade® (infliximab, anti-TNF? monoclonal antibody); Reopro® (abciximab, anti-GP IIb/IIia receptor monoclonal antibody); Actemra® (anti-IL6 Receptor mAb); Avastin® (bevacizumab), HuMax-CD4 (zanolimumab); Mvasi™ (bevacizumab-awwb); Rituxan® (rituximab, anti-CD20 mAb); Tarceva® (erlotinib); Roferon-A®-(interferon alfa-2a); Simulect® (basiliximab); Prexige® (lumiracoxib); Synagis® (palivizumab); 145c7-CHO (anti-IL15 antibody, see U.S. Pat. No. 7,153,507); Tysabri® (natalizumab, anti-? 4integrin mAb); Valortim® (MDX-1303, anti-B. anthracis protective antigen mAb); ABthrax™; Xolair® (omalizumab); ETI211 (anti-MRSA mAb); IL-1 trap (the Fc portion of human IgG1 and the extracellular domains of both IL-1 receptor components (the Type I receptor and receptor accessory protein)); VEGF trap (Ig domains of VEGFR1 fused to IgG1 Fc); Zenapax® (daclizumab); Zenapax® (daclizumab, anti-IL-2R? mAb); Zevalin® (ibritumomab tiuxetan); Zetia® (ezetimibe); Orencia® (atacicept, TACI-Ig); anti-CD80 monoclonal antibody (galiximab); anti-CD23 mAb (lumiliximab); BR2-Fc (huBR3/huFc fusion protein, soluble BAFF antagonist); CNTO 148 (golimumab, anti-TNF? mAb); HGS-ETR1 (mapatumumab; human anti-TRAIL Receptor-1 mAb); HuMax-CD20 (ocrelizumab, anti-CD20 human mAb); HuMax-EGFR (zalutumumab); M200 (volociximab, anti-? 5?1 integrin mAb); MDX-010 (ipilimumab, anti-CTLA-4 mAb and VEGFR-1 (IMC-18F1); anti-BR3 mAb; anti-C. difficile Toxin A and Toxin B C mAbs MDX-066 (CDA-1) and MDX-1388); anti-CD22 dsFv-PE38 conjugates (CAT-3888 and CAT-8015); anti-CD25 mAb (HuMax-TAC); anti-CD3 mAb (NI-0401); adecatumumab; anti-CD30 mAb (MDX-060); MDX-1333 (anti-IFNAR); anti-CD38 mAb (HuMax CD38); anti-CD40L mAb; anti-Cripto mAb; anti-CTGF Idiopathic Pulmonary Fibrosis Phase I Fibrogen (FG-3019); anti-CTLA4 mAb; anti-eotaxin1 mAb (CAT-213); anti-FGF8 mAb; anti-ganglioside GD2 mAb; anti-ganglioside GM2 mAb; anti-GDF-8 human mAb (MYO-029); anti-GM-CSF Receptor mAb (CAM-3001); anti-HepC mAb (HuMax HepC); anti-IFN? mAb (MEDI-545, MDX-198); anti-IGF1R mAb; anti-IGF-1R mAb (HuMax-Inflam); anti-IL12 mAb (ABT-874); anti-IL12/IL23 mAb (CNTO 1275); anti-IL13 mAb (CAT-354); anti-IL2Ra mAb (HuMax-TAC); anti-IL5 Receptor mAb; anti-integrin receptors mAb (MDX-018, CNTO 95); anti-IP10 Ulcerative Colitis mAb (MDX-1100); BMS-66513; anti-Mannose Receptor/hCG? mAb (MDX-1307); anti-mesothelin dsFv-PE38 conjugate (CAT-5001); anti-PD1mAb (MDX-1106 (ONO-4538)); anti-PDGFR? antibody (IMC-3G3); anti-TGFβ mAb (GC-1008); anti-TRAIL Receptor-2 human mAb (HGS-ETR2); anti-TWEAK mAb; anti-VEGFR/FIt-1 mAb; and anti-ZP3 mAb (HuMax-ZP3).

In some embodiments, the drug delivery device may contain or be used with a sclerostin antibody, such as but not limited to romosozumab, blosozumab, BPS 804 (Novartis), Evenity™ (romosozumab-aqqg), another product containing romosozumab for treatment of postmenopausal osteoporosis and/or fracture healing and in other embodiments, a monoclonal antibody (IgG) that binds human Proprotein Convertase Subtilisin/Kexin Type 9 (PCSK9). Such PCSK9 specific antibodies include, but are not limited to, Repatha® (evolocumab) and Praluent® (alirocumab). In other embodiments, the drug delivery device may contain or be used with rilotumumab, bixalomer, trebananib, ganitumab, conatumumab, motesanib diphosphate, brodalumab, vidupiprant or panitumumab. In some embodiments, the reservoir of the drug delivery device may be filled with or the device can be used with IMLYGIC® (talimogene laherparepvec) or another oncolytic HSV for the treatment of melanoma or other cancers including but are not limited to OncoVEXGALV/CD; OrienX010; G207, 1716; NV1020; NV12023; NV1034; and NV1042. In some embodiments, the drug delivery device may contain or be used with endogenous tissue inhibitors of metalloproteinases (TIMPs) such as but not limited to TIMP-3. In some embodiments, the drug delivery device may contain or be used with Aimovig® (erenumab-aooe), anti-human CGRP-R (calcitonin gene-related peptide type 1 receptor) or another product containing erenumab for the treatment of migraine headaches. Antagonistic antibodies for human calcitonin gene-related peptide (CGRP) receptor such as but not limited to erenumab and bispecific antibody molecules that target the CGRP receptor and other headache targets may also be delivered with a drug delivery device of the present disclosure. Additionally, bispecific T cell engager (BiTE®) molecules such as but not limited to BLINCYTO® (blinatumomab) can be used in or with the drug delivery device of the present disclosure. In some embodiments, the drug delivery device may contain or be used with an APJ large molecule agonist such as but not limited to apelin or analogues thereof. In some embodiments, a therapeutically effective amount of an anti-thymic stromal lymphopoietin (TSLP) or TSLP receptor antibody is used in or with the drug delivery device of the present disclosure. In some embodiments, the drug delivery device may contain or be used with Avsola™ (infliximab-axxq), anti-TNF? monoclonal antibody, biosimilar to Remicade® (infliximab) (Janssen Biotech, Inc.) or another product containing infliximab for the treatment of autoimmune diseases. In some embodiments, the drug delivery device may contain or be used with Kyprolis® (carfilzomib), (2S)—N—((S)-1-((S)-4-methyl-1-((R)-2-methyloxiran-2-yl)-1-oxopentan-2-ylcarbamoyl)-2-phenylethyl)-2-((S)-2-(2-morpholinoacetamido)-4-phenylbutanamido)-4-methylpentanamide, or another product containing carfilzomib for the treatment of multiple myeloma. In some embodiments, the drug delivery device may contain or be used with Otezla® (apremilast), N-[2-[(1S)-1-(3-ethoxy-4-methoxyphenyl)-2-(methylsulfonyl)ethyl]-2,3-dihydro-1,3-dioxo-1H-isoindol-4-yl]acetamide, or another product containing apremilast for the treatment of various inflammatory diseases. In some embodiments, the drug delivery device may contain or be used with Parsabiv™ (etelcalcetide HCl, KAI-4169) or another product containing etelcalcetide HCl for the treatment of secondary hyperparathyroidism (sHPT) such as in patients with chronic kidney disease (KD) on hemodialysis. In some embodiments, the drug delivery device may contain or be used with ABP 798 (rituximab), a biosimilar candidate to Rituxan®/MabThera™, or another product containing an anti-CD20 monoclonal antibody. In some embodiments, the drug delivery device may contain or be used with a VEGF antagonist such as a non-antibody VEGF antagonist and/or a VEGF-Trap such as aflibercept (Ig domain 2 from VEGFR1 and Ig domain 3 from VEGFR2, fused to Fc domain of IgG1). In some embodiments, the drug delivery device may contain or be used with ABP 959 (eculizumab), a biosimilar candidate to Soliris®, or another product containing a monoclonal antibody that specifically binds to the complement protein C5. In some embodiments, the drug delivery device may contain or be used with Rozibafusp alfa (formerly AMG 570) is a novel bispecific antibody-peptide conjugate that simultaneously blocks ICOSL and BAFF activity. In some embodiments, the drug delivery device may contain or be used with Omecamtiv mecarbil, a small molecule selective cardiac myosin activator, or myotrope, which directly targets the contractile mechanisms of the heart, or another product containing a small molecule selective cardiac myosin activator. In some embodiments, the drug delivery device may contain or be used with Sotorasib (formerly known as AMG 510), a KRASG12C small molecule inhibitor, or another product containing a KRASG12C small molecule inhibitor. In some embodiments, the drug delivery device may contain or be used with Tezepelumab, a human monoclonal antibody that inhibits the action of thymic stromal lymphopoietin (TSLP), or another product containing a human monoclonal antibody that inhibits the action of TSLP. In some embodiments, the drug delivery device may contain or be used with AMG 714, a human monoclonal antibody that binds to Interleukin-15 (IL-15) or another product containing a human monoclonal antibody that binds to Interleukin-15 (IL-15). In some embodiments, the drug delivery device may contain or be used with AMG 890, a small interfering RNA (siRNA) that lowers lipoprotein(a), also known as Lp(a), or another product containing a small interfering RNA (siRNA) that lowers lipoprotein(a). In some embodiments, the drug delivery device may contain or be used with ABP 654 (human IgG1 kappa antibody), a biosimilar candidate to Stelara®, or another product that contains human IgG1 kappa antibody and/or binds to the p40 subunit of human cytokines interleukin (IL)-12 and IL-23. In some embodiments, the drug delivery device may contain or be used with Amjevita™ or Amgevita™ (formerly ABP 501) (mab anti-TNF human IgG1), a biosimilar candidate to Humira®, or another product that contains human mab anti-TNF human IgG1. In some embodiments, the drug delivery device may contain or be used with AMG 160, or another product that contains a half-life extended (HLE) anti-prostate-specific membrane antigen (PSMA)×anti-CD3 BiTE® (bispecific T cell engager) construct. In some embodiments, the drug delivery device may contain or be used with AMG 119, or another product containing a delta-like ligand 3 (DLL3) CAR T (chimeric antigen receptor T cell) cellular therapy. In some embodiments, the drug delivery device may contain or be used with AMG 119, or another product containing a delta-like ligand 3 (DLL3) CAR T (chimeric antigen receptor T cell) cellular therapy. In some embodiments, the drug delivery device may contain or be used with AMG 133, or another product containing a gastric inhibitory polypeptide receptor (GIPR) antagonist and GLP-1R agonist. In some embodiments, the drug delivery device may contain or be used with AMG 171 or another product containing a Growth Differential Factor 15 (GDF15) analog. In some embodiments, the drug delivery device may contain or be used with AMG 176 or another product containing a small molecule inhibitor of myeloid cell leukemia 1 (MCL-1). In some embodiments, the drug delivery device may contain or be used with AMG 199 or another product containing a half-life extended (HLE) bispecific T cell engager construct (BiTE®). In some embodiments, the drug delivery device may contain or be used with AMG 256 or another product containing an anti-PD-1×IL21 mutein and/or an IL-21 receptor agonist designed to selectively turn on the Interleukin 21 (IL-21) pathway in programmed cell death-1 (PD-1) positive cells. In some embodiments, the drug delivery device may contain or be used with AMG 330 or another product containing an anti-CD33×anti-CD3 BiTE® (bispecific T cell engager) construct. In some embodiments, the drug delivery device may contain or be used with AMG 404 or another product containing a human anti-programmed cell death-1 (PD-1) monoclonal antibody being investigated as a treatment for patients with solid tumors. In some embodiments, the drug delivery device may contain or be used with AMG 427 or another product containing a half-life extended (HLE) anti-fms-like tyrosine kinase 3 (FLT3)×anti-CD3 BiTE® (bispecific T cell engager) construct. In some embodiments, the drug delivery device may contain or be used with AMG 430 or another product containing an anti-Jagged-1 monoclonal antibody. In some embodiments, the drug delivery device may contain or be used with AMG 506 or another product containing a multi-specific FAP×4-1BB-targeting DARPin® biologic under investigation as a treatment for solid tumors. In some embodiments, the drug delivery device may contain or be used with AMG 509 or another product containing a bivalent T-cell engager and is designed using XmAb® 2+1 technology. In some embodiments, the drug delivery device may contain or be used with AMG 562 or another product containing a half-life extended (HLE) CD19×CD3 BiTE® (bispecific T cell engager) construct. In some embodiments, the drug delivery device may contain or be used with Efavaleukin alfa (formerly AMG 592) or another product containing an IL-2 mutein Fc fusion protein. In some embodiments, the drug delivery device may contain or be used with AMG 596 or another product containing a CD3×epidermal growth factor receptor vIII (EGFRVIII) BiTE® (bispecific T cell engager) molecule. In some embodiments, the drug delivery device may contain or be used with AMG 673 or another product containing a half-life extended (HLE) anti-CD33×anti-CD3 BiTE® (bispecific T cell engager) construct. In some embodiments, the drug delivery device may contain or be used with AMG 701 or another product containing a half-life extended (HLE) anti-B-cell maturation antigen (BCMA)×anti-CD3 BITER (bispecific T cell engager) construct. In some embodiments, the drug delivery device may contain or be used with AMG 757 or another product containing a half-life extended (HLE) anti-delta-like ligand 3 (DLL3)×anti-CD3 BiTE® (bispecific T cell engager) construct. In some embodiments, the drug delivery device may contain or be used with AMG 910 or another product containing a half-life extended (HLE) epithelial cell tight junction protein claudin 18.2×CD3 BiTE® (bispecific T cell engager) construct.

Although the drug delivery devices, assemblies, components, subsystems and methods have been described in terms of exemplary embodiments, they are not limited thereto. The detailed description is to be construed as exemplary only and does not describe every possible embodiment of the present disclosure. Numerous alternative embodiments could be implemented, using either current technology or technology developed after the filing date of this patent that would still fall within the scope of the claims defining the invention(s) disclosed herein.

Those skilled in the art will recognize that a wide variety of modifications, alterations, and combinations can be made with respect to the above described embodiments without departing from the spirit and scope of the invention(s) disclosed herein, and that such modifications, alterations, and combinations are to be viewed as being within the ambit of the inventive concept(s).

1. A method of lyophilizing a target material, the method comprising:
placing a container with a target material in a lyophilizer of a lyophilization system, the lyophilization system comprising the lyophilizer, a refrigeration system coupled to the lyophilizer, a controller coupled to the refrigeration system, and a flow path connecting the lyophilizer and the refrigeration system;
activating the lyophilizer, wherein the lyophilizer includes a plurality of walls defining an interior chamber and at least one shelf disposed in the interior chamber;
performing a freezing cycle by reducing a temperature of the at least one shelf;
performing a primary drying cycle by increasing the temperature of the at least one shelf;
performing a secondary drying cycle;
pumping a thermal fluid through the flow path during the freezing cycle, the primary drying cycle, and the secondary drying cycle, wherein the flow path is in fluid communication with the at least one shelf and in selective fluid communication with at least one wall of the plurality of walls; and
opening a valve disposed on the flow path during at least a portion of at least one of the freezing cycle and the secondary drying cycle to pump the thermal fluid through the at least one wall of the plurality of walls.

2. The method of claim 1, wherein performing the freezing cycle includes opening the valve disposed in a first conduit of the flow path connected to the at least one wall of the plurality of walls, and pumping thermal fluid into the at least one wall of the plurality of walls.

3. The method of claim 1, wherein performing the secondary drying cycle includes removing a portion of a remaining adsorbed or bound moisture from the target material to complete dehydration.

4. The method of claim 1, wherein performing the secondary drying cycle includes opening the valve and pumping thermal fluid into the at least one wall of the plurality of walls.

5. The method of claim 4, wherein opening the first conduit includes connecting the refrigeration system with the plurality of walls.

6. The method of claim 1, wherein performing the freezing cycle includes pumping the thermal fluid through the at least one shelf.

7. The method of claim 2, further comprising closing the valve before performing the primary drying cycle.

8. The method of claim 7, wherein closing the valve shunts thermal fluid from entering the at least one wall of the plurality of walls.

9. The method of claim 2, further comprising capturing, by at least one sensor associated with the first conduit, sensor data associated with a temperature of the thermal fluid flowing through the at least one wall of the plurality of walls of the lyophilizer.

10. The method of claim 9, further compromising analyzing, by one or more processors of the temperature controller, the sensor data associated with the temperature of the thermal fluid flowing through the at least one wall of the plurality of walls.

11. The method of claim 10, further comprising identifying, by one or more processors, based on an analysis of the sensor data, a status or condition associated with the temperature of the thermal fluid flowing through the at least one wall of the plurality of walls.

12. The method of claim 11, further comprising sending a signal to the valve to open or close based on the status or condition identified.

13. A lyophilization system comprising:
a plurality of walls defining a chamber;
a shelf disposed in the chamber;
a first conduit in fluid communication with at least one of the plurality of walls;
a second conduit in fluid communication with the shelf;
a valve operatively coupled to the first conduit;
a sensor coupled to the first conduit to capture sensor data associated with a temperature of a thermal fluid flowing through the first conduit;
a controller communicatively coupled to the lyophilizer to perform a freezing cycle, a primary drying cycle, and a secondary drying cycle, the controller comprising:
one or more processors;
a memory communicatively coupled to the one or more processors and storing executable instructions that, when executed by the one or more processors, causes the one or more processors to:
receive sensor data captured by the at least one sensor;
analyze the sensor data to identify a status or condition associated with the temperature of the thermal fluid flowing through the first conduit during at least one of the freezing cycle, primary drying cycle, and secondary drying cycle; and
send a signal to the valve to open or close based on the status or condition identified during the at least one of the freezing cycle, primary drying cycle, and secondary drying cycle.

14. The system of claim 13, further comprising a refrigeration system communicatively coupled to the controller, wherein the executable instructions cause the one or more processors to send a signal to the refrigeration system to pump a thermal fluid based on a status or condition associated with the temperature of the thermal fluid flowing through the first conduit.

15. The lyophilization system of claim 13, comprising a network of conduits including the first conduit and the second conduit.

16. The lyophilization system of claim 13, wherein the first conduit is in fluid communication with the plurality of walls defining the chamber.

17. The lyophilization system of claim 13, wherein the plurality of walls includes a first sidewall, a second sidewall, a ceiling, and a floor.

18. A method of lyophilizing a target material, the method comprising:
placing a container with a target material in a lyophilizer of a lyophilization system, the lyophilization system comprising the lyophilizer, a refrigeration system coupled to the lyophilizer, a temperature controller coupled to the refrigeration system, and a flow path connecting the lyophilizer and the refrigeration system;
activating the lyophilizer, wherein the lyophilizer includes a plurality of walls defining an interior chamber and at least one shelf disposed in the interior chamber;
performing a freezing cycle;
performing a primary drying cycle; and
performing a secondary drying cycle;
capturing, by at least one sensor associated with a first conduit of the flow path, sensor data associated with a temperature of the thermal fluid flowing through the at least one wall of the plurality of walls of the lyophilizer;
analyzing, by one or more processors of the temperature controller, the sensor data associated with the temperature of the thermal fluid flowing through the at least one wall of the plurality of walls;
identifying, by one or more processors, based on an analysis of the sensor data, a status or condition associated with the temperature of the thermal fluid flowing through the at least one wall of the plurality of walls;
sending, during at least one of the freezing cycle, the primary drying cycle, and the secondary drying cycle, a signal to a valve to open or close based on the status or condition identified, wherein the valve is disposed in a first conduit of the flow path, the flow path including the first conduit connected to the at least one wall of the plurality of walls and a second conduit connected to the at least one shelf.

19. The method of claim 18, further comprising pumping a thermal fluid through the flow path during at least one of the freezing cycle, the primary drying cycle, and the secondary drying cycle.

20. The method of claim 18, further comprising opening and closing the valve during pumping such that when the valve is open, thermal fluid is pumped into the first conduit and the second conduit, and when the valve is closed, thermal fluid is pumped into the second conduit.
